(19) United States
(12) Patent Application Publication
(10) Pub. No.: US 2016/0260389 A1
(43) Pub. Date: Sep. 8, 2016

(54) BACKLIGHT MODULE, DISPLAY DEVICE AND DRIVING METHOD THEREOF

(71) Applicant: SHENZHEN CHINA STAR OPTOELECTRONICS TECHNOLOGY CO., LTD., Shenzhen, Guangdong (CN)

(72) Inventors: Yong FAN, Shenzhen (CN); Chih tsung KANG, Shenzhen (CN); Sheng Jer CHANG CHIEN, Shenzhen (CN)

(21) Appl. No.: 14/406,687

(22) PCT Filed: May 30, 2014
(86) PCT No.: PCT/CN2014/079016

§ 371 Date: Dec. 9, 2014

(30) Foreign Application Priority Data
May 23, 2014 (CN) 201410222197.3

(51) Int. Cl. G09G 3/34; G09G 3/36

(52) U.S. Cl. CPC G09G 3/3413; G09G 3/3607; G09G 3/3696; G09G 2310/08; G09G 2320/0242; G09G 2310/0237

(57) ABSTRACT

The present disclosure relates to a backlight module, a display device and a driving method thereof in the technical field of display, for solving the technical problem that an existing FSC liquid crystal display may have a color break up phenomenon. The backlight module includes a controller and a plurality of subarea backlights, wherein each of the subarea backlights includes at least two light sources driven independently and having different colors, and the controller is configured to control the respective turn-on time of the light sources of different colors in each subarea backlight. The present disclosure can be suitable for a liquid crystal television, a liquid crystal display, a mobile phone, a flat panel computer, and the like.

The present application claims the priority of Chinese Patent Application CN 201410222197.3, filed on May 23, 2014 and entitled “BACKLIGHT MODULE, DISPLAY DEVICE AND DRIVING METHOD THEREOF”, the entire contents of which are herein incorporated by reference.

### Field of the Invention

The present disclosure relates to the technical field of display, in particular to a backlight module, a display device and a driving method thereof.

### BACKGROUND OF THE INVENTION

With the development of display technology, liquid crystal display (LCD) has become the most common flat panel display device. In one kind of liquid crystal displays which can display images through field sequential color (FSC), no filter layers of red, green and blue are necessary, so that the loss of light may be reduced, and the utilization rate of a backlight source may be improved.

In the existing FSC liquid crystal display, images are displayed according to the following principle. That is, each frame of image is divided into three color fields displayed in sequence. In the first color field, the backlight module only emits red light, and a liquid crystal module is driven to display the red part of the frame of image; in the second color field, the backlight module only emits green light, and the liquid crystal module is driven to display the green part of the frame of image; and in the third color field, the backlight module only emits blue light, and the liquid crystal module is driven to display the blue part of the frame of image. When the three color fields are seen sequentially, they can be combined into the frame of image at human eyes.

However, the existing FSC liquid crystal display at least suffers from the following technical problem. During the display process, if a relative movement is generated between the human eyes and the FSC liquid crystal display, then the three color fields sequentially seen by the human eyes will be located on different positions in the human eyes. Therefore, the red part, green part and blue part of the frame of image will be combined in a dislocated manner, thus forming a distorted image. Namely, a color break up phenomenon occurs.

### SUMMARY OF THE INVENTION

The present disclosure aims to provide a backlight module, a display device and a driving method thereof, for solving the technical problem that an existing FSC liquid crystal display may have a color break up phenomenon.

The present disclosure provides a backlight module, including a controller and a plurality of subarea backlights. Each of the subarea backlights includes at least two light sources driven independently and having different colors. The controller is configured to control the respective turn-on time of the light sources of different colors in each subarea backlight.

Preferably, each subarea backlight includes a red light source, a blue light source and green fluorescent powder arranged around the blue light source.

Preferably, the green fluorescent powder is sulfide fluorescent powder, aluminate fluorescent powder, phosphate fluorescent powder, borate fluorescent powder, silicate fluorescent powder, nitrogen oxide fluorescent powder or quantum dot fluorescent powder.

Alternatively, each subarea backlight includes a red light source, a blue light source and a green light source.

Preferably, the subarea backlight has a rectangular shape.

Preferably, the subarea backlights are arranged in an array.

Preferably, the quantity of the subarea backlights is from 200 to 36,864.

The present disclosure further provides a display device, including a liquid crystal module and the above-mentioned backlight module.

Preferably, the liquid crystal module includes a plurality of pixel units, each pixel unit including a transparent sub-pixel, a green sub-pixel and a blue sub-pixel. A transparent filter layer or no filter layer is arranged in the transparent sub-pixel, a green filter layer is arranged in the green sub-pixel, and a blue filter layer is arranged in the blue sub-pixel

In addition, the display device further includes: an image information processing unit, which is configured to, according to a frame of image to be displayed by the display device, determine the respective turn-on time of light sources of different colors in each subarea backlight of the backlight module in this frame, and the driving voltage of each sub-pixel unit in the liquid crystal module; and a signal processor, which is configured to, according to the determined driving voltage, drive each sub-pixel unit in the liquid crystal module.

Further, the display device also includes a clock controller, which is configured to perform time matching on the signal processor and the controller in the backlight module.

The present disclosure further provides a method for driving the above-mentioned display device. The method includes, in a frame of image displayed by the display device: determining, based on this frame of image, the respective turn-on time of light sources of different colors in each subarea backlight of the backlight module in this frame and the driving voltage of each sub-pixel unit in the liquid crystal module, through the image information processing unit; turning on, based on the determined turn-on time, the light sources of different colors in each subarea backlight of the backlight module, through the controller in the backlight module; and driving, based on the determined driving voltage, each sub-pixel unit in the liquid crystal module, through the signal processor.

The following beneficial effects can be achieved according to the present disclosure. With the backlight module according to the present disclosure, a frame of image to be displayed may be firstly divided into a plurality of subarea images during the display process, each subarea image corresponding to a respective subarea backlight of the backlight module. The controller in the backlight module controls the respective turn-on time of the light sources of different colors in each subarea backlight in this frame, namely, controls the duty cycle of the light sources of different colors in this frame, in order to control the chromaticity and brightness of each subarea backlight. In this manner, the chromaticity and brightness of each subarea backlight may approach the subarea image associated with the subarea backlight. Meanwhile, each sub-pixel unit in the liquid crystal module is driven in such a manner that after the light emitted by the subarea backlight passes through the liquid crystal module, the subarea image associated with the subarea backlight may be displayed. By means of which, a frame of complete image can be formed through the subarea images.

In the backlight module according to the present disclosure, each subarea backlight controls the duty cycles of the light sources of different colors according to the associated subarea image, so that the power consumption of the backlight module can be reduced, and the utilization rate of the backlights can be improved. Particularly, when a subarea image is of one single color, only the light sources of one color in the associated subarea backlight are necessary to be turned on. Therefore, the power consumption of the backlight module can be reduced more significantly, and the utilization rate of the backlights can be further improved. Moreover, with the backlight module according to the present disclosure, the liquid crystal module only needs to be driven once during the process of displaying a frame of image. Consequently, the FSC display will not be adopted while the utilization rate of light can be improved, and thus the technical problem that a color break up phenomenon occurs in the existing FSC display can be solved.

Other features and advantages of the present disclosure will be set forth in the following description, and in part will be self-evident from the description, or be learned through implementing the present disclosure. The objectives and other advantages of the present disclosure may be achieved and obtained by structures particularly pointed out in the description, the claims and the accompanying drawings.

### BRIEF DESCRIPTION OF THE DRAWINGS

To illustrate technical solutions in the embodiments of the present disclosure or in the prior art more clearly, a brief introduction on the accompanying drawings which are needed in the description of the embodiments or the prior art is given below:

FIG. 1 is a schematic diagram of a backlight module provided by embodiment I according to the present disclosure;

FIG. 2 is a schematic diagram of a subarea backlight in the backlight module provided by embodiment I according to the present disclosure;

FIG. 3 is a schematic diagram of a display device provided by embodiment I according to the present disclosure;

FIG. 4 is another schematic diagram of a display device provided by embodiment I according to the present disclosure; and

FIG. 5 is a schematic diagram of a subarea backlight in a backlight module provided by embodiment II according to the present disclosure.

### DETAILED DESCRIPTION OF THE EMBODIMENTS

A detailed description of the implementation of the present disclosure will be given below, in combination with the accompanying drawings and embodiments, therefore, an implementation process of how to use technical means of the present disclosure to solve technical problems and achieve a technical effect may be fully understood and implemented accordingly. It should be noted that, as long as no conflict is generated, various embodiments of the present disclosure and various features of the embodiments may be combined with each other, and the formed technical solutions are all within the protection scope of the present disclosure.

### Embodiment I

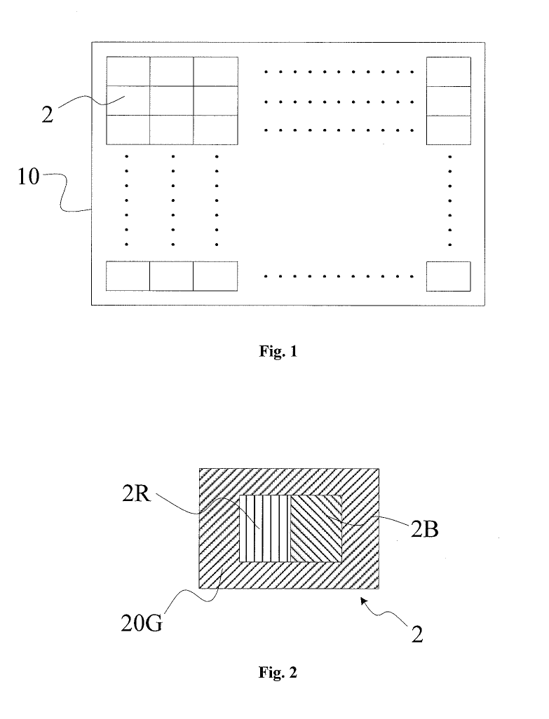

As shown in FIG. 1, this embodiment of the present disclosure provides a backlight module 10, including a controller and a plurality of subarea backlights 2. The controller is not shown in FIG. 1 since it is generally arranged below the subarea backlights. The subarea backlights 2 are preferably rectangular, and have the same shape and size.

The subarea backlights 2 may be arranged in an array, close to each other, with a total quantity of 200 to 36,864. For example, there are 600 subarea backlights 2 provided in total, which may be arranged in an array of 30*20. In another example, when the backlight module 10 is applied to an ultrahigh definition (UD) television with a resolution of 3,840*2,160, there may provide a total of 36,864 subarea backlights 2, which are arranged in the array of 256*144. In this case, each subarea backlight 2 serves as a backlight source for only 225 (15*15) pixel units.

Each subarea backlight includes at least two light sources driven independently and having different colors. As shown in FIG. 2, in this embodiment, each subarea backlight 2 includes a red light source 2R, a blue light source 2B, and green fluorescent powder 20G arranged around the blue light source. The red light source 2R and the blue light source 2B are preferably LEDs. The green fluorescent powder 20G may be sulfide fluorescent powder, aluminate fluorescent powder, phosphate fluorescent powder, borate fluorescent powder, silicate fluorescent powder, nitrogen oxide fluorescent powder, or quantum dot fluorescent powder.

The controller is configured to control the respective turn-on time of the light sources of different colors in each subarea backlight. In this embodiment, the controller may control the turn-on time of the red light source 2R and the blue light source 2B in each subarea backlight within a frame of time, namely, control the duty cycles of the red light source 2R and the blue light source 2B within a frame of time. By means of which, the chromaticity and brightness of each subarea backlight 2 within the frame of time can be controlled, so that each subarea backlight 2 may have chromaticity and brightness different from other ones.

The embodiment of the present disclosure further provides a display device, which specifically may be a liquid crystal television, a liquid crystal display, a mobile phone, a flat panel computer, and the like. The display device includes a liquid crystal module, and the above-mentioned backlight module as provided by the embodiment according to the present disclosure.

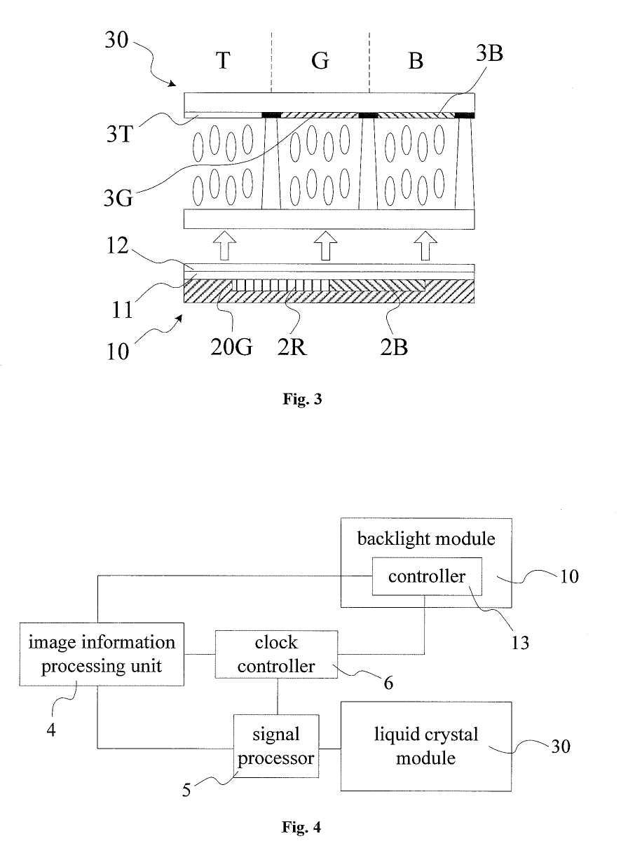

As shown in FIG. 3, in this embodiment, the liquid crystal module 30 includes a plurality of pixel units, each pixel unit including a transparent sub-pixel T, a green sub-pixel G and a blue sub-pixel B. A transparent filter layer 3T or no transparent filter layer is arranged in the transparent sub-pixel T, a green filter layer 3G is arranged in the green sub-pixel G, and a blue filter layer 3B is arranged in the blue sub-pixel B.

The light emitted by the red light source 2R, the blue light source 2B and the green fluorescent powder 20G in each subarea backlight 2 passes through light mixing components such as a diffuser 11, a prism 12 and the like in the backlight module 10, and then enters the liquid crystal module 30. In the liquid crystal module 30, the blue sub-pixel B may transmit blue light, the green sub-pixel G may transmit green light, and the transparent sub-pixel T may transmit light of all colors. Because the transparent sub-pixel T may transmit the light of all colors, the transmittance of the whole liquid crystal module 30 and the utilization rate of the backlights can be improved, and the brightness of displayed images can be improved.

As shown in FIG. 4, the display device provided by the embodiment according to the present disclosure further includes an image information processing unit 4 and a signal processor 5. The image information processing unit 4 is configured to, based on a frame of image to be displayed by the display device, determine the respective turn-on time of the red light source and the blue light source in each subarea backlight of the backlight module 10 in this frame, and the driving voltage of each sub-pixel unit in the liquid crystal module 30.

The controller 13 in the backlight module 10 may turn on the red light source and the blue light source in each subarea backlight of the backlight module 10 according to the turn-on time as determined, so that the subarea backlights may have different chromaticity and brightness. On the other hand, the signal processor 5 drives each sub-pixel unit in the liquid crystal module 30 according to the determined driving voltage, so that after the light emitted by the backlight module 10 passes through the liquid crystal module 30, the frame of image can be displayed.

In this embodiment, the display device may further include a clock controller 6, which is configured to perform time matching on the signal processor 5 and the controller 13 in the backlight module 10, so as to ensure that the light emitted by the backlight module 10 and the drive of the liquid crystal module 30 are performed on the same frame of image.

The embodiment according to the present disclosure further provides a method for driving the above-mentioned display device. Specifically, in a frame of image displayed by the display device, the turn-on time of the red light source and the blue light source in each subarea backlight of the backlight module in this frame and the driving voltage of each sub-pixel unit in the liquid crystal module are determined firstly according to this frame of image.

As shown in FIG. 4, specifically, this frame of image may be divided into a plurality of subarea images by the image information processing unit 4, each subarea image corresponding to a respective subarea backlight of the backlight module 10.

The image information processing unit 4 determines the respective turn-on time of the red light source and the blue light source in each subarea backlight in this frame according to each subarea image, namely, controls the duty cycle of the red light source and the blue light source in this frame, so as to control the chromaticity and brightness of each subarea backlight. Therefore, the chromaticity and brightness of each subarea backlight may approach the subarea image corresponding to the subarea backlight.

For example, in this embodiment, the subarea backlight 2 includes the red light source 2R, the blue light source 2B (and the green fluorescent powder 20G), as shown in FIG. 2. If a certain subarea image contains more red but less blue and green, in the subarea backlight 2 corresponding to the subarea image, the turn-on time of the red light source 2R is longer, and that of the blue light source 2B is shorter. Namely, the duty cycle of the red light source 2R is larger, and that of the blue light source 2B is smaller. If a certain subarea image is of single red (or merely contains red of different gray scales), only the red light source 2R is turned on in the subarea backlight 2 corresponding to the subarea image, without the blue light source 2B being turned on. Namely, the duty cycle of the red light source 2R is 1, and that of the blue light source 2B is 0. In this manner, the power consumption of the blue light source 2B may be significantly reduced in the subarea backlight 2, and the loss of blue light can be avoided.

It should be noted that, the duty cycle of the red light source 2R is independent from that of the blue light source 2B, and the sum of both duty cycles is not certainly equal to 1. When a certain subarea image is white with relatively high brightness, both the duty cycle of the red light source 2R and that of the blue light source 2B may be equal to 1 in the subarea backlight 2 corresponding to said subarea image. And when a certain subarea image is black, both the duty cycle of the red light source 2R and that of the blue light source 2B may be equal to 0 in the subarea backlight 2 corresponding to said subarea image.

On the other hand, as shown in FIG. 4, the image information processing unit 4 further determines the driving voltage of each sub-pixel unit in the liquid crystal module 30, according to each subarea image and the chromaticity and brightness of the corresponding subarea backlight.

Then, the red light source and the blue light source in each subarea of the backlight module are turned on according to the turn-on time, determined by the image information processing unit 4, of the red light source and the blue light source in each subarea backlight in this frame.

Specifically, the controller 13 in the backlight module 10 controls the turn-on time of the red light source and the blue light source in each subarea backlight within the frame of time, namely, the duty cycles of the red light source and the blue light source within the frame of time, so that the chromaticity and brightness of each subarea backlight are controlled. In this manner, the chromaticity and brightness of each subarea backlight may approach the subarea image corresponding to said subarea backlight. Since the chromaticity and brightness of each subarea backlight approach the subarea image corresponding thereto, the light emitted by the whole backlight module 10 consisting of the subarea backlights will form a relatively fuzzy image approaching the frame of image to be displayed before passing through the liquid crystal module 30.

Meanwhile, the signal processor 5 drives each sub-pixel unit in the liquid crystal module 30 according to the driving voltage of each sub-pixel unit determined by the image information processing unit 4, so that after the light emitted by each subarea backlight passes through the liquid crystal module 30, the corresponding subarea image may be displayed. In this manner, the subarea images may constitute a frame of complete image, thus realizing display of the image.

In the display process of the display device provided by the embodiment according to the present disclosure, a frame of image to be displayed may be firstly divided into a plurality of subarea images by the image information processing unit 4, each subarea image corresponding to a respective subarea backlight of the backlight module 10. The image information processing unit 4 then determines, according to each subarea image, the duty cycles of the red light source and the blue light source in the subarea backlight associated with said subarea image within the frame of time, and the driving voltage of each sub-pixel unit in the liquid crystal module 30.

The controller 13 in the backlight module 10 controls the duty cycles of the red light source and the blue light source in each subarea backlight in this frame according to the duty cycles determined by the image information processing unit 4, so as to control the chromaticity and brightness of each subarea backlight. Therefore, the chromaticity and brightness of each subarea backlight may approach the subarea image corresponding to said subarea backlight. In this manner, the light emitted by the whole backlight module 10 consisting of the subarea backlights will form a relatively fuzzy image approaching the frame of image to be displayed before passing through the liquid crystal module 30.

Meanwhile, the signal processor 5 drives each sub-pixel unit in the liquid crystal module 30 according to the driving voltage determined by the image information processing unit 4, so that after the light emitted by each subarea backlight passes through the liquid crystal module 30, the corresponding subarea image may be displayed. In this way, the subarea images may constitute a frame of complete image, thus realizing display of the image.

In the backlight module provided by the embodiment according to the present disclosure, each subarea backlight controls the duty cycles of the red light source and the blue light source according to the corresponding subarea image, so that the power consumption of the backlight module may be reduced, and the utilization rate of the backlights may be improved. Particularly, when a subarea image has a single color (or merely has a single color of different gray scales), only the light source of this color needs to be turned on in the corresponding subarea backlight, so that the power consumption of the backlight module can be reduced more significantly, and the utilization rate of the backlights can be improved. Moreover, the larger the number of the subarea backlights is, the smaller the area of each subarea backlight is, the smaller the area of the subarea image corresponding to said subarea backlight is, and the easier the appearance of the subarea image of the single color (or the single color of different gray scales) is. Consequently, the power consumption of the backlight module can be reduced to a larger extent, and the utilization rate of the backlights can be improved.

On the other hand, with the backlight module according to the present disclosure, the liquid crystal module only needs to be driven once in the process of displaying a frame of image, so that the utilization rate of light can be improved without use of the FSC display. Consequently, the technical problem that a color break up phenomenon occurs in the existing FSC display can be solved.

Moreover, in the existing FSC display of three color fields, each frame of image is divided into three color fields. In this case, if the liquid crystal display needs to display at the refresh rate of 60 Hz, the practical refresh rate of the liquid crystal display should reach 180 Hz. In contrast, in the display device according to the embodiment of the present disclosure, no FSC display is used. If the frame of image needs to be displayed at the refresh rate of 60 Hz, the practical refresh rate is still 60 Hz. Therefore, the display device according to the embodiment of the present disclosure has lower requirements for the refresh rate and response speed (response time) of liquid crystals, so that the display device according to the embodiment of the present disclosure is lower in cost, and may be implemented more easily in multiple patterns of in-plane switching (IPS), vertical alignment (VA), twisted nematic (TN) and the like.

### Embodiment II

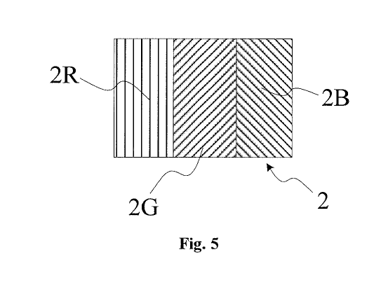

As shown in FIG. 5, the backlight module provided by this embodiment of the present disclosure is substantially the same as that provided by embodiment I, and the difference lies in that in the backlight module 10 provided by this embodiment, each subarea backlight 2 includes a red light source 2R, a blue light source 2B and a green light source 2G which are driven independently. The controller (not shown in the figure) in the backlight module 10 may control the duty cycles of the red light source 2R, the blue light source 2B and the green light source 2G in the subarea backlight 2 within a frame of time, so that the chromaticity and brightness of each subarea backlight 2 within the frame of time can be controlled. In this manner, the backlights 2 may have different chromaticity and brightness.

The display device provided by the embodiment of the present disclosure includes a backlight module and a liquid crystal module. The backlight module can be the above-mentioned backlight module as provided by this embodiment, whereas the liquid crystal module is the same as that in embodiment I, wherein each pixel unit of the liquid crystal module includes a transparent sub-pixel, a green sub-pixel and a blue sub-pixel.

The display device provided by the embodiment of the present disclosure further includes an image information processing unit, a signal processor and a clock controller, the functions and driving method of which are substantially the same as those in embodiment I. Specifically, for the driving method, in a frame of image displayed by the display device, the image information processing unit firstly divides the frame of image into a plurality of subarea images, each subarea image corresponding to a respective subarea backlight of the backlight module.

Then, the respective duty cycles of the red light source, the blue light source and the green light source in each subarea backlight in this frame are determined according to each subarea image, so as to control the chromaticity and brightness of each subarea backlight. In this manner, the chromaticity and brightness of each subarea backlight may approach the subarea image corresponding to the subarea backlight.

As shown in FIG. 5, if a certain subarea image contains more red but less blue and green, in the subarea backlight 2 corresponding to the subarea image, the red light source 2R has a larger duty cycle, while the blue light source 2B and the green light source 2G have smaller duty cycles. If a certain subarea image is of single red (or merely contains red of different gray scales), in the subarea backlight 2 corresponding to the subarea image, only the red light source 2R is turned on, with the blue light source 2B and the green light source 2G not being turned on. Namely, the duty cycle of the red light source 2R is 1, and the duty cycles of the blue light source 2B and the green light source 2G are both 0. In this way, the power consumption of the blue light source 2B and the green light source 2G may be significantly reduced in the subarea backlight 2, and the loss of blue light and green light can be avoided.

On the other hand, the image information processing unit also determines the driving voltage of each sub-pixel unit in the liquid crystal module according to each subarea image and the chromaticity and brightness of the corresponding subarea backlight.

Then, the red light source, the blue light source and the green light source in each subarea of the backlight module are turned on according to the respective duty cycles, determined by the image information processing unit, of the red light source, the blue light source and the green light source in each subarea backlight in this frame.

Specifically, the controller in the backlight module controls the respective duty cycles of the red light source, the blue light source and the green light source in each subarea backlight within the frame of time, so that the chromaticity and brightness of each subarea backlight can be controlled, and the chromaticity and brightness of each subarea backlight may approach the subarea image corresponding to the subarea backlight. Since the chromaticity and brightness of each subarea backlight approach the subarea image corresponding to the subarea backlight, the light emitted by the whole backlight module consisting of the subarea backlights will form a relatively fuzzy image approaching the frame of image to be displayed before passing through the liquid crystal module.

Meanwhile, the signal processor drives each sub-pixel unit in the liquid crystal module according to the driving voltage determined by the image information processing unit, so that after the light emitted by each subarea backlight passes through the liquid crystal module, the corresponding subarea image may be displayed. In this way, the subarea images may constitute a frame of complete image, thus realizing display of the image.

In the backlight module provided by the embodiment according to the present disclosure, each subarea backlight controls the duty cycles of the red light source and the blue light source according to the corresponding subarea image, so that the power consumption of the backlight module may be reduced, and the utilization rate of the backlights may be improved. Particularly, when a subarea image has a single color (or merely has a single color of different gray scales), only the light source of this color needs to be turned on in the corresponding subarea backlight, so that the power consumption of the backlight module can be reduced more significantly, and the utilization rate of the backlights can be improved. Moreover, the larger the number of the subarea backlights is, the smaller the area of each subarea backlight is, the smaller the area of the subarea image corresponding to said subarea backlight is, and the easier the appearance of the subarea image of the single color (or the single color of different gray scales) is. Consequently, the power consumption of the backlight module can be reduced to a larger extent, and the utilization rate of the backlights can be improved.

On the other hand, with the backlight module according to the present disclosure, the liquid crystal module only needs to be driven once in the process of displaying a frame of image, so that the utilization rate of light can be improved without use of the FSC display. Consequently, the technical problem that a color break up phenomenon occurs in the existing FSC display can be solved.

Moreover, in the existing FSC display of three color fields, each frame of image is divided into three color fields. In this case, if the liquid crystal display needs to display at the refresh rate of 60 Hz, the practical refresh rate of the liquid crystal display should reach 180 Hz. In contrast, in the display device according to the embodiment of the present disclosure, no FSC display is used. If the frame of image needs to be displayed at the refresh rate of 60 Hz, the practical refresh rate is still 60 Hz. Therefore, the display device according to the embodiment of the present disclosure has lower requirements for the refresh rate and response speed (response time) of liquid crystals, so that the display device according to the embodiment of the present disclosure is lower in cost, and may be implemented more easily in multiple patterns of IPS, VA, TN and the like.

### Embodiment III

The embodiment of the present disclosure provides a display device, including a backlight module, a liquid crystal module, an image information processing unit, a signal processor, a clock controller, and other components. The backlight module, the image information processing unit, the signal processor and the clock controller are the same as those in embodiment I or embodiment II. In this embodiment, each pixel unit of the liquid crystal module includes a red sub-pixel, a green sub-pixel and a blue sub-pixel, wherein a red filter layer is arranged in the red sub-pixel, a green filter layer is arranged in the green sub-pixel, and a blue filter layer is arranged in the blue sub-pixel.

That is, the liquid crystal module in embodiment I or embodiment II is replaced with a liquid crystal module with a structure of common red, green and blue pixels. The functions of the backlight module, the image information processing unit, the signal processor, the clock controller and other components and the driving method for the display device are substantially the same as those in embodiment I or embodiment II.

Compared with the transparent sub-pixels in embodiment I or embodiment II, only red light may penetrate through the red sub-pixels in this embodiment, so that the total transmittance of the display device is relatively low. However, the effect of reducing the power consumption may still be achieved in this embodiment by controlling the duty cycles of the light sources of different colors in the subarea backlights.

Moreover, the FSC display is not adopted in this embodiment, so the problem that a color break up phenomenon occurs in the FSC display is solved. Further, the display device provided by this embodiment has a lower requirement for the refresh rate, so that the display device may be implemented more easily by using the liquid crystal module of multiple patterns such as EPS, VA, TN and the like.

Although the implementations disclosed by the present disclosure are described above, the contents are implementations merely adopted to facilitate understanding of the present disclosure, rather than limiting the present disclosure. Any skilled in the art to which the present disclosure pertains may make any modifications and variations on the implementation form and detail without departing from the disclosed spirit and scope of the present disclosure, but the patent protection scope of the present disclosure shall be subject to the scope defined by the appended claims.

1. A backlight module, including a controller and a plurality of subarea backlights, wherein each of the subarea backlights includes at least two light sources driven independently and having different colors, and the controller is configured to control the respective turn-on time of the light sources of different colors in each subarea backlight.

2. The backlight module according to claim 1, wherein each subarea backlight includes a red light source, a blue light source, and green fluorescent powder arranged around the blue light source.

3. The backlight module according to claim 2, wherein the green fluorescent powder is one selecting from a group consisting of sulfide fluorescent powder, aluminate fluorescent powder, phosphate fluorescent powder, borate fluorescent powder, silicate fluorescent powder, nitrogen oxide fluorescent powder, and quantum dot fluorescent powder.

4. The backlight module according to claim 1, wherein each subarea backlight includes a red light source, a blue light source, and a green light source.

5. The backlight module according to claim 1, wherein the subarea backlight has a rectangular shape.

6. The backlight module according to claim 1, wherein the subarea backlights are arranged in an array.

7. The backlight module according to claim 1, wherein the quantity of the subarea backlights is from 200 to 36,864.

8. A display device, comprising a liquid crystal module and a backlight module, said backlight module including a controller and a plurality of subarea backlights, wherein each of the subarea backlights includes at least two light sources driven independently and having different colors, and the controller is configured to control the respective turn-on time of the light sources of different colors in each subarea backlight.

9. The display device according to claim 8, wherein the liquid crystal module includes a plurality of pixel units, each pixel unit including a transparent sub-pixel, a green sub-pixel and a blue sub-pixel; and
wherein transparent filter layer or no filter layer is arranged in the transparent sub-pixel, a green filter layer is arranged in the green sub-pixel, and a blue filter layer is arranged in the blue sub-pixel

10. The display device according to claim 8, wherein the display device further includes:
an image information processing unit, which is configured to, according to a frame of image to be displayed by the display device, determine the respective turn-on time of light sources of different colors in each subarea backlight of the backlight module in this frame, and the driving voltage of each sub-pixel unit in the liquid crystal module; and
a signal processor, which is configured to, according to the determined driving voltage, drive each sub-pixel unit in the liquid crystal module.

11. The display device according to claim 10, wherein the display device further includes a clock controller, which is configured to perform time matching on the signal processor and the controller in the backlight module.

12. A method for driving a display device comprising a liquid crystal module and a backlight module,
said backlight module including a controller and a plurality of subarea backlights, wherein each of the subarea backlights includes at least two light sources driven independently and having different colors, and the controller is configured to control the respective turn-on time of the light sources of different colors in each subarea backlight,
the method including, in a frame of image displayed by the display device:
determining, based on the frame of image, the respective turn-on time of light sources of different colors in each subarea backlight of the backlight module in this frame and the driving voltage of each sub-pixel unit in the liquid crystal module, through the image information processing unit;
turning on, based on the determined turn-on time, the light sources of different colors in each subarea backlight of the backlight module, through the controller in the backlight module; and
driving, based on the determined driving voltage, each sub-pixel unit in the liquid crystal module, through the signal processor.
